(19) United States
(12) Patent Application Publication
(10) Pub. No.: US 2004/0212156 A1
(43) Pub. Date: Oct. 28, 2004

(54) Metallic joint with fibrous insert

(76) Inventor: Fabrizio Bric-Carello, Torino (IT)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/477,297

(22) PCT Filed: May 7, 2002
(86) PCT No.: PCT/FR02/01571

(30) Foreign Application Priority Data
May 9, 2001 (FR) 01 06129

(51) Int. Cl. F16L 17/00

(52) U.S. Cl. 277/602

(57) ABSTRACT

A metallic joint for use to ensure tightness at the connection between two parts subjected to high heat stresses that includes at least two plates having at least an opening, at least one of the plates including at least a rib enclosing the opening and arranged at some distance from the edge of said opening. The metallic joint includes an insert made of composite material, arranged between the rib and the edge, said material being resistant to heat stresses and preserving its elasticity in the course of time.

The present invention relates to a metal joint having a fibrous insert specifically intended for exhaust manifolds and flanges subject to high heat stresses.

Metal joints are used at the connections between two pipes to provide a seal, and are generally formed of at least one metal sheet having a rib that can deform elastically to ensure tightness, particularly when the parts in contact deform due to expansion.

When they are subjected to high heat stresses which produce relatively large deformations, for example when applied to exhaust manifolds, such joints have two metal sheets each having a rib, the sheets being situated symmetrically and level with each other.

Under cold conditions the ribs are crushed by the tightening force, while under hot conditions, due to expansion phenomena, the parts in contact tend to pull apart while the ribs deform elastically to maintain continuous contact between the metal sheets of the joint, thus ensuring a seal.

However, the strong and frequent temperature fluctuations to which the metal joint is subjected bring about a hardening phenomenon that tends to sharply reduce the modulus of elasticity of the joint. Once they lose their elasticity, the ribs no longer perform their sealing function and become embrittled, with fissures appearing at their ridges.

Hence, the object of the present invention is to mitigate the drawbacks of the related art metal joints by providing a simply designed metal joint that can preserve its mechanical properties over time, particularly its elasticity, when subjected to strong, frequent temperature fluctuations.

For this purpose, the present invention relates to a metal joint that can be used to provide a seal at the connection between two pipes of two parts subjected to high heat stresses, formed of at least two metal sheets in which at least one opening is provided, at least one of the sheets having at least one rib surrounding the opening and located at a certain distance from the edge of the opening, characterized in that it includes an insert made of a composite material situated between the rib and the edge, the composite material withstanding heat stresses and retaining its elasticity over time.

Advantageously, the insert is made of a fibrous composite material.

According to another feature, the insert may have variable geometric or mechanical properties along the circumference.

According to one preferred embodiment, the two metal sheets forming the joint each have a rib situated symmetrically and level with each other, the insert being situated between the edge of the opening and the ribs.

Preferably, the edge of the opening has a crimp to grip the insert between the two metal sheets.

According to another feature, the edge of one of the two sheets is bent and cladded against the other sheet, then undergoes a flattening operation so that the top surface of the edge is situated essentially at the same level as the top surface of the sheet that it partially covers, the latter forming an indentation that can accommodate the edge.

Other features and advantages emerge from the description below, provided as a single example with reference to the attached figures:

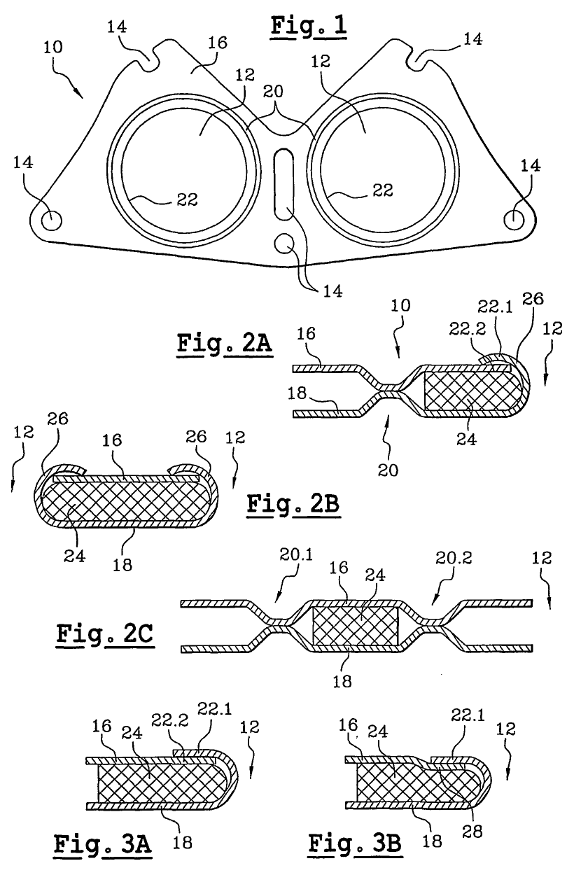

FIG. 1 shows a plan view of a metal joint according to the present invention,

FIG. 2A shows a cross-section view of a first arrangement,

FIG. 2B shows a cross-section view of a second arrangement,

FIG. 2C shows a cross-section view of a third arrangement,

FIG. 3A shows a cross-section view of a first embodiment, and

FIG. 3B shows a cross-section view of another embodiment.

FIG. 1 shows a side view of a metal joint 10 used in particular for an exhaust manifold undergoing high heat stresses, namely large temperature fluctuations and/or highly frequent heating cycles.

Like all joints, this joint provides a seal at the connection between two pipes of two parts between which it is situated.

For example, the joint shown in FIG. 1 has two openings 12 to ensure continuity of the passages between the parts located on either side of the joint, as well as orifices or notches 14 to allow components joining the parts, for example screws or pins, to pass through.

The following description of the particular arrangement of the present invention refers to a single opening, which may optionally be duplicated at other openings or orifices.

According to the present invention, joint 10 has at least two metal sheets 16, 18, at least one of which has a rib 20 surrounding opening 12 and is situated at a certain distance from edge 22 of the opening.

The material of the sheet bearing the rib is such that it confers some elasticity on the latter, allowing it to deform in such a way as to ensure tightness of the connection, even when the parts situated on either side of the joint significantly expand.

According to the present invention, to protect the rib from heating so that it retains its full elasticity over time, an insert 24 made of a composite material, ring-shaped in this case, is situated between rib 20 and edge 22, the composite material retaining its elasticity over time despite the heat stresses. Preferably, insert 24 is made of a fibrous composite material. More particularly, the fibers are mineral fibers, and specifically contain refractory ceramics.

According to one improved feature, the composite material is chosen from materials that tend to expand at the operating temperatures in order to improve the seal.

Thus, insert 24 compensates for small movements by retaining its elasticity over time and protects the rib or ribs 20 from heat so that the latter retain their elasticity over time and compensate for the large clearances produced in particular by expansion deformations.

Depending on the nature and density of the insert material, the insert area may be an actual stop whose adaptability is appropriate for the tightening and flatness requirements of the parts located on either side of the joint.

According to another feature, insert 24 may have variable geometric or mechanical properties along the circumference in order to optimally adjust the latter to operating conditions, particularly tightening forces which are not uniform over the surface of the joint.

As illustrated in the various figures, to improve the seal and compensate for major clearances, the two sheets of joint 10 each have a rib 20 situated symmetrically and level with each other, insert 24 being situated between edge 22 of opening 12 and ribs 20.

According to another feature illustrated in FIGS. 2A, 2B, 3A, and 3B, edge 22 of the opening has a crimp 26 in order to grip insert 24 between the two sheets 16, 18, with edge 22.1 of sheet 18 being bent in order to cover edge 22.2 of sheet 16.

According to a first embodiment illustrated by FIG. 3A, edge 22.1 of sheet 18 is just cladded to sheet 16, forming an indentation.

According to another embodiment illustrated in FIG. 3B, edge 22.1 of sheet 18 is cladded against sheet 16 and undergoes a flattening operation so that the top surface of edge 22.1 is situated essentially at the same level as the top surface of sheet 16, the latter forming an indentation 28 that can accommodate edge 22.1.

In this case, it should be noted that insert 24 becomes denser in the area where the two sheets overlap, leading to predensification of this part of the insert and improving the seal so that it is no longer necessary to re-tighten assembled parts after a lapse of time.

Supplementing crimp 26, rib or ribs 20 surrounding insert 24 sharply reduce the likelihood that the latter will creep.

Depending on the arrangement, the insert may be in the form of rings or a plate in which one or more openings are provided. In FIG. 2B, insert 24 is common to two openings 12 and is preferably in the form of two rings connected by an isthmus.

According to another arrangement illustrated in FIG. 2C, insert 24 is gripped between two ribs or two sets of concentric ribs 20.1 and 20.2 so that edge 22 of opening 12 no longer necessarily has a crimp. This configuration can be used to improve the seal locally or distribute the tightening pressure more favorably.

Of course, the invention is not confined to the embodiment shown and described above, but on the contrary covers all variants thereof, particularly with regard to the number and material of the sheets, the presence or absence of one or more ribs on each sheet, the elasticity and thickness of the sheets, and the nature and thickness of the fibrous composite material.

1-10. (canceled)

11. A metal joint for providing a seal at a connection between two pipes of two parts subjected to heat stresses, the metal joint comprising:
a first metal sheet;
a second metal sheet, at least one of the sheets defining an opening and having a rib surrounding the opening, the rib located at a distance from an edge of the opening; and
an insert including a composite material disposed between the rib and the edge, the composite material configured to withstand heat stresses and to retain elasticity over time.

12. The metal joint as recited in claim 11, wherein the insert includes a fibrous composite material.

13. The metal joint as recited in claim 12, wherein the insert includes a fibrous composite material of mineral origin.

14. The metal joint as recited in claim 11, wherein the composite material tends to expand at an operating temperature of the two parts so as to improve the seal.

15. The metal joint as recited in claim 11, wherein a geometric property of the insert varies along a circumference of the insert.

16. The metal joint as recited in claim 11, wherein a mechanical property of the insert varies along a circumference of the insert.

17. The metal joint as recited in claim 11, wherein both the first and second metal sheets have a rib, the ribs being disposed symmetrically and level with each other, the insert being disposed between the edge of the opening and the ribs.

18. The metal joint as recited in claim 11, further comprising a crimp disposed at the edge of the opening and configured to grip the insert between the first and second metal sheets.

19. The metal joint as recited in claim 18, wherein an edge portion the first sheet is bent and cladded against an edge portion of the second sheet.

20. The metal joint as recited in claim 18, wherein an edge portion the first sheet is cladded against an edge portion of the second sheet so as to form an indentation.

21. The metal joint as recited in claim 18, wherein an edge portion of the first sheet is bent and cladded against an edge portion of the second sheet and flattened so that a top surface of the edge portion of the first sheet is disposed at a same level as a top surface of the second sheet and partially covering the top surface of the second sheet.

22. The metal joint as recited in claim 21, wherein the edge portion of the first sheet forms an indentation that accommodates the edge.

23. The metal joint as recited in claim 11 wherein both the first and second metal sheets have a rib and the insert is disposed between the two ribs.

24. The metal joint as recited in claim 11 wherein both the first and second metal sheets have a set of concentric ribs and the insert is disposed between the two sets of concentric ribs.
